(19) United States
(12) Patent Application Publication
(10) Pub. No.: US 2010/0131555 A1
(43) Pub. Date: May 27, 2010

(54) DOUBLE LINK SEARCH SYSTEM AND METHOD FOR DISPLAYING STARTING POSITION OF SEARCH KEYWORD IN SEARCH RESULT PAGE

(76) Inventor: Chang-Mo Kim, Gyeonggi-Do (KR)

Correspondence Address: EDWARDS ANGELL PALMER & DODGE LLP, P.O. BOX 55874, BOSTON, MA, 02205, US

(21) Appl. No.: 12/593,193

(22) PCT Filed: Apr. 4, 2008
(86) PCT No.: PCT/KR08/01925

§ 371 Date: Sep. 25, 2009

(30) Foreign Application Priority Data
Apr. 5, 2007 (KR) 10-2007-0033786

(51) Int. Cl. G06F 17/30; G06F 3/048

(52) U.S. Cl. 707/770; 715/819; 707/E17.014; 707/E17.032; 707/E17.115

(57) ABSTRACT

A double link search system, which when a user inputs a search keyword in a wire or wireless network and inquires out search results, provides the user with a link page displaying a sentence starting with the search keyword, comprises means for receiving a search request including a search keyword from a user terminal; means for collecting search results corresponding to the search keyword from information sites; means for storing a URL (Uniform Resource Locator) of each information site where the search results are located and a unique URL of a search server corresponding to the URL of each information site; means for generating a search result page including search result items, each item having the URL of the search server; and means for providing the user terminal with the search result page.

### CROSS-REFERENCE TO RELATED APPLICATIONS

This application claims priority to Korean patent application no. 10-2007-0033786 in its entirety.

### BACKGROUND OF THE INVENTION

The present invention relates to double link search system and method for displaying search results starting with a search keyword to a user, and in particular, a double link search system, which when a user is provided with a search result page and clicks a search result link on the search result page, displays search results starting with a search keyword on a corresponding web page, and a double link search method.

### BRIEF SUMMARY OF THE INVENTION

In order to solve the above-mentioned problems, it is an object of the present invention to provide double link search system and method, in which when a user selects a specific link on a search result page, a site where a corresponding link page actually exists is not displayed, instead a search server receives a request for a link page, requests the link page to a corresponding site, receives the link page, searches the content of the link page, recognizes a location structure of a search keyword, and displays a sentence starting with the search keyword on a web browser of the user.

In order to solve the above-mentioned problems, a double link search system according to the present invention, which when a user inputs a search keyword in a wire or wireless network and inquires for search results, provides the user with a link page displaying a sentence starting with the search keyword, comprises means for receiving a search request including a search keyword from a user terminal; means for collecting search results corresponding to the search keyword from information sites; means for storing a URL of each information site where the search results are located and a unique URL of a search server corresponding to the URL of each information site; means for generating a search result page including search result items, each item having the URL of the search server; and means for providing the user terminal with the search result page.

According to a preferred feature of the present invention, in the search result page, each search result item has the URL of the search server, and the URL includes the search keyword.

Preferably, the search server stores the generated search result page in a memory, and when receiving a search request of the same search keyword from the user terminal, the search server inquires out the stored search result page and responds to the user terminal.

Preferably, the search server includes means for receiving a request for a link page of a specific search result item using the URL of the search server of the search result page from the user terminal; means for inquiring out a URL of an information site corresponding to the URL of the search server from a DB (database), requesting a link page, and receiving the corresponding link page; means for inserting an unique ID (identification) information into each location of the search keyword among data of the received link page to edit the link page; and means for providing the user terminal with the edited link page.

Further, in the case that the search keyword is positioned at least two locations in the received link page, the link page has a “next” button inserted therein, and when the “next” button is selected by a user, the “next” button allows the user to directly move to a next sentence starting with the search keyword.

Preferably, the search server inserts a connection button into each search result item of the search result page, the connection button giving a link to an actual site of the search result item.

Meanwhile, a double link search method according to the present invention, in which when a user inputs a search keyword in a wire or wireless network and inquires out search results, a search server provides the user with a link page displaying a sentence starting with the search keyword, comprises (810) a search server receiving a search request including a search keyword from a user terminal; (S20) collecting search results corresponding to the search keyword from information sites; (S30) storing a URL of each information site where the search results are located and a unique URL of the search server corresponding to the URL of each information site; (840) generating a search result page including search result items, each item having the URL of the search server; and (S50) providing the user terminal with the search result page.

### BRIEF DESCRIPTION OF THE DRAWINGS

Preferred embodiments of the present invention will be more fully described in the following detailed description, taken accompanying drawings. However, it should be understood that the description proposed herein is just a preferable example for the purpose of illustrations only, not intended to limit the scope of the invention. In the drawings:

FIG. 1 is a schematic block diagram illustrating a search system in a conventional single link environment, and

FIGS. 2 to 4 are views illustrating examples of search result pages in the conventional single link environment.

FIG. 5 is a schematic block diagram illustrating a double link search system according to the present invention.

FIG. 6 is an internal configuration diagram illustrating a search server according to an embodiment of the present invention.

FIG. 7 is a flow chart illustrating a double link search method according to an embodiment of the present invention.

FIGS. 8 to 12 are views illustrating examples of search result pages and search data according to an embodiment of the present invention.

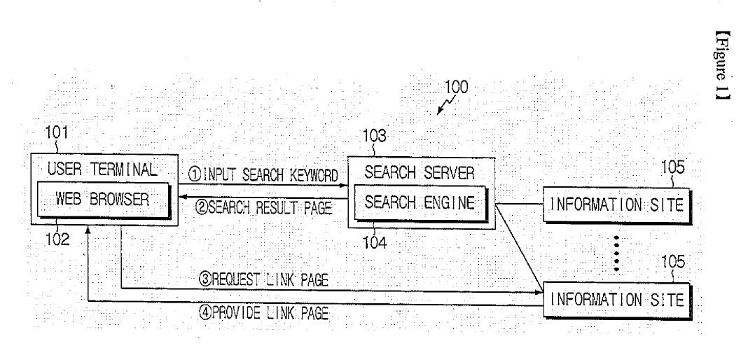

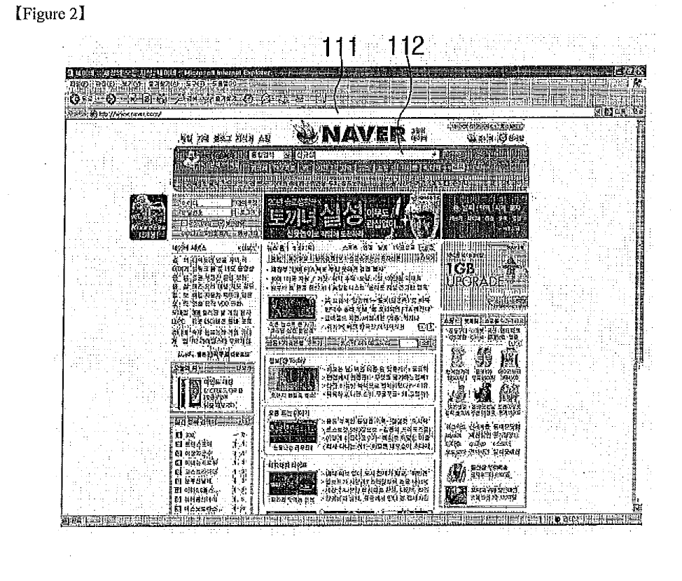

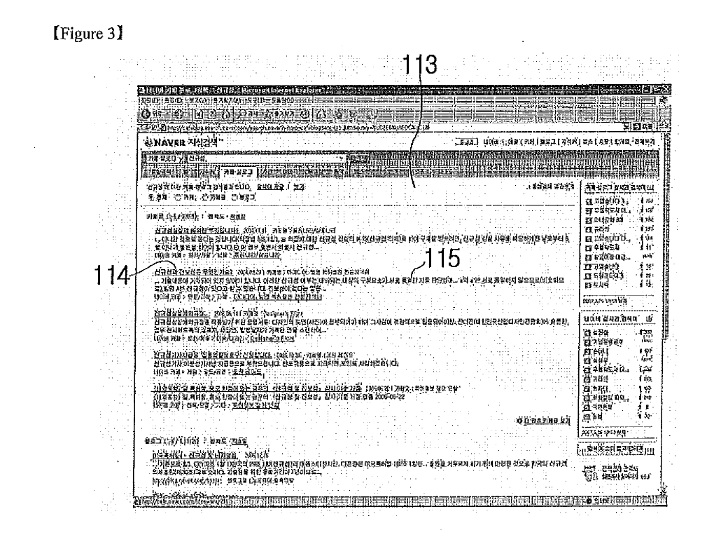

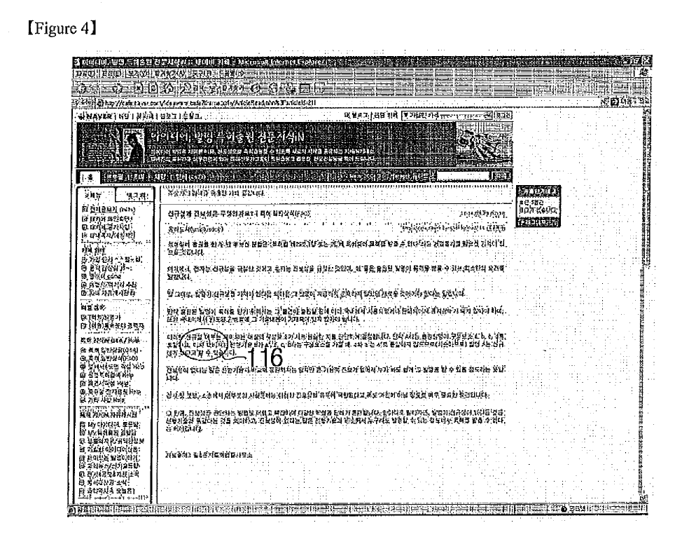

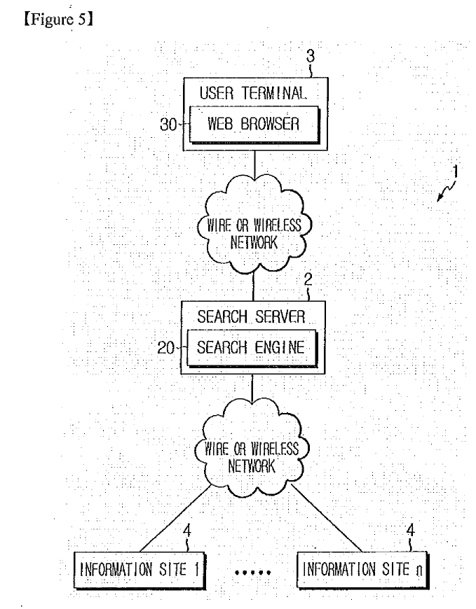

FIG. 5 is a schematic block diagram illustrating a double link search system 1 according to the present invention.

### DETAILED DESCRIPTION OF THE INVENTION

The double link search system 1 of the present invention, which is built in a wire or wireless network environment, comprises a user terminal 3 for making a search request by a user's input of a search keyword, a search server 2 for receiving the search request of the user terminal 3, providing a search result page, in which an actual URL address of a search result is replaced with an address of the search server 2, and providing a link page displaying a sentence starting with the search keyword at the user's request for more detailed information, and information sites 4 used for search to collect data related to the search keyword of the user.

The user terminal 3 connects to a web server through a wire or wireless network to receive a web page and displays the web page. A user inputs a search keyword into an address window of a web browser 30 or a search window of a specific web site, presses a search button, and receives a search result page. The user checks information of the search result page, and in the case that the user wants more detailed information, he/she selects a specific link. The web browser 30 receives and displays the full text of a link page using a URL corresponding to the selected link. At this time, when displaying the link page, the present invention displays a sentence starting with the search keyword inputted by the user, and thus allows the user to look for his/her desired information rapidly.

The search server 2 receives the user's search request including the search keyword from the user terminal 3. When the search server 2 receives the search request, a search engine 20 collects data related to the search keyword from the information sites 4. The collected data is arranged on a search result page according to search result item. Each search result item includes a unique URL information where information (for example, text or web page) is actually stored.

Conventionally, the URL information was an address of an information site where information is actually located, however in the present invention, a URL address of the search server 2 is designated and used to generate a search result page. Therefore, when a user is provided with a search result page and clicks a specific search result item for more detailed information, the present invention does not request a detailed information to an actual information site 4, but to the search server 3 (primary link). And, the search server 2 extracts a URL of the actual information site 4 from a URL of the requested search server 2. When the information site URL is extracted, the search server 2 requests a detailed information to the information site 4 corresponding to the extracted address and receives data (secondary link). Here, the search server 2 of the present invention provides a search service using a double link.

The search server 2 gives an ID to each location of the search keyword in the original data received from the information site 4 through analysis, and inserts the ID into the location of the search keyword to generate a link page. When the user terminal 3 is provided with the link page, a sentence starting with the search keyword having the ID is displayed from the first line of a screen. Therefore, unlike the prior art, the present invention eliminates the need that the user looks for a sentence including the search keyword on a link page with his/her eyes.

The information site 4 stores various contents related to the search keyword. For example, the information site 4 may be a portal site, a site of a news paper publishing company, a site of a government agency or a site of a school, and is not limited to a specific kind. The search engine 20 of the search server 2 collects data related to the search keyword of the user among web data stored in the information site 4.

FIG. 6 is an internal configuration diagram illustrating the search server 2 according to an embodiment of the present invention.

The search server 2 according to an embodiment of the present invention is configured to provide a search result page resulted from a primary search of a search keyword of a user, and includes a search request receiving means 21 for receiving a search request of the user, a search result collecting means 22 for collecting data related to the search keyword, a search result address storing means 23 for storing an actual URL of a search result and a URL of the search server 2 corresponding to the URL of the search result, a search result page generating means 24 for generating a search result page linked to the URL of the search server 2, and a search result page providing means 25 for providing the user terminal 3 with the generated search result page.

In addition, as a configuration for providing a link page in the case that the user selects a specific item on the search result page for more detailed information, the search server 2 further includes a link page request receiving means 26 for receiving a request for a link page selected by the user on the search result page, a link page receiving means 27 for extracting an actual URL address from a link address and receiving the link page, a link page editing means 28 for inserting an ID into each location of the search keyword on the received link page, and a link page providing means 29 for providing the edited link page.

The search request receiving means 21 receives a search request from the user terminal 3. The search request includes the search keyword inputted by the user.

The search result collecting means 22 collects search result data from the information sites 4 using the search keyword of the user.

The search result address storing means 23 gives a unique URL address of the search server 2 to a URL of search result data in each information site 4 where search results are located, and stores them in a search result address DB 230. The URL address of the search server 2 is conformable to a general address format for connection.

The search result page generating means 24 arranges search result data linked to the unique URL of the search server 2 for each search result item to generate a search result page. In the prior art, the link address is a URL of an actual information site where data is located, however in the present invention, the link address is a URL of the search server 2.

Preferably, the URL of the search server 2 further includes the search keyword inputted by the user. This allows the search server 2 to recognize the search keyword when the user selects a corresponding link.

Further, the generated search result page may be stored in a DB, and thus in the case that a search request of the same search keyword is received next time, the stored search result page is immediately provided without collecting search result data from the information sites 4. And, an independent server may be built to store a one-time generated search result page.

Furthermore, the search server 2 inserts a direct connection button into each search result item in the search result page so that a user can directly link to an actual information site 4 where a page of a search result item is stored. For example, when a user is provided with a product of a specific shopping mall as a search result on a search result page, the user clicks a search result item to connect to the search server 2 and is provided with a corresponding web page. Thus, in the case that the user connects to the shopping mall and wants to purchase the corresponding product, the user should connect to the shopping mall via the search server 2. Preferably, for the purpose of direct connection, the search server 2 inserts a direct connection button into each search result item, and in the case that the button is pressed, the search server 2 allows the user to directly link to the actual information site 4.

The search result page providing means 25 provides the generated search result page to the user terminal 3. When the user is provided with the search result page, he/she is provided with data related to the search keyword inputted by himself/herself according to search result item. And, when the user selects a specific item for more detailed information, the search server 2 receives a request for link information, but not the actual information site 4 where data is located. This is because the search result page generating means 24 links each search result item to the URL address of the search server 2.

The link page request receiving means 26 receives selection of a specific search result item from the user in such a state that the user terminal 3 displays the entire search result page resulted from a primary search, and receives a request for a link page that is located at a URL of a corresponding link (the search server 2).

The link page receiving means 27 extracts a URL of the information site 4 from the search result DB 230 using the URL of the link (URL of the search server 2) received from the user terminal 3. When the information site URL is extracted, the link page receiving means 27 requests a corresponding web data to the information site 4 using the information site URL and receives a corresponding link page.

The link page editing means 28 analyzes data of the received link page, and generates and inserts an individual ID into each location of the search keyword. Therefore, the edited link page has an ID information in each location of the search keyword of the original data. The ID is used to recognize a starting portion of a sentence including the search keyword.

Preferably, in the case that the search keyword is positioned at a plurality of locations, the link page editing means 28 gives different IDs to the locations and inserts a “next” button into a link page. In the case that the “next” button is selected by the user, the “next” button allows the user to directly move to a next sentence starting with the search keyword, not to look for the search keyword with his/her eyes on the link page.

The link page providing means 29 provides the user terminal 3 with the edited link page as data of detailed search.

The double link search method according to the present invention for displaying search results starting with a search keyword to a user can be preferably implemented through construction of the above-mentioned double link search system 1.

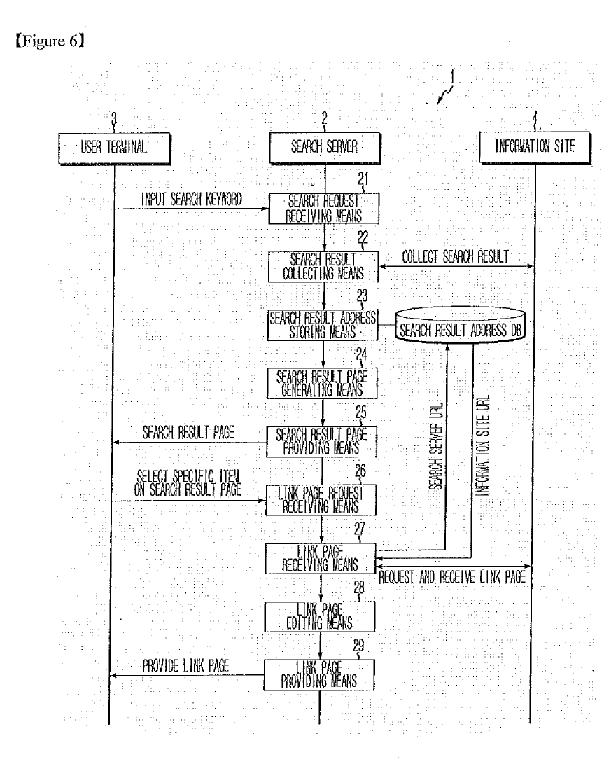

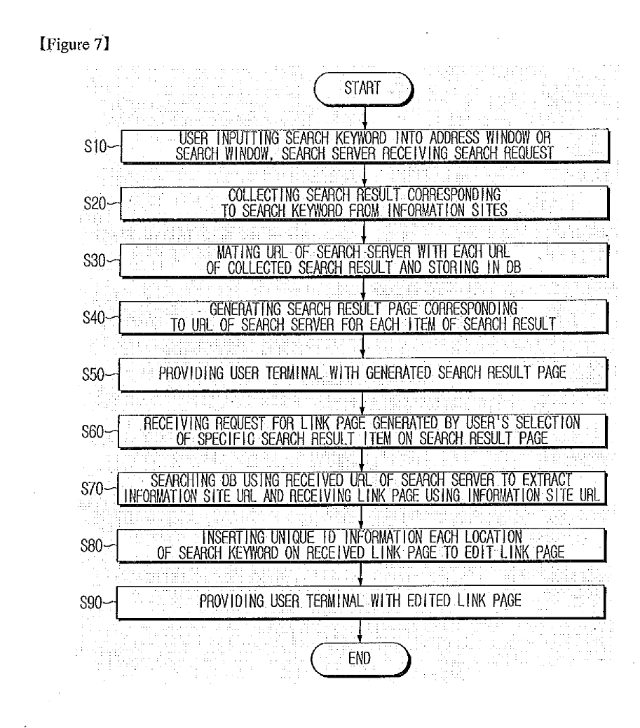

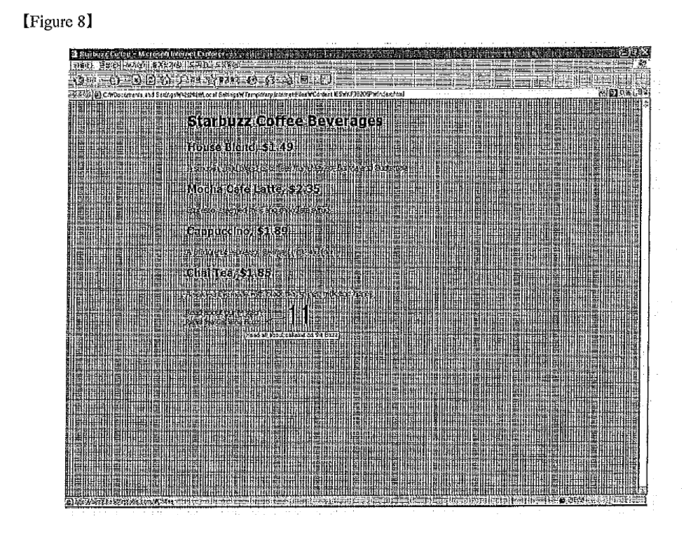

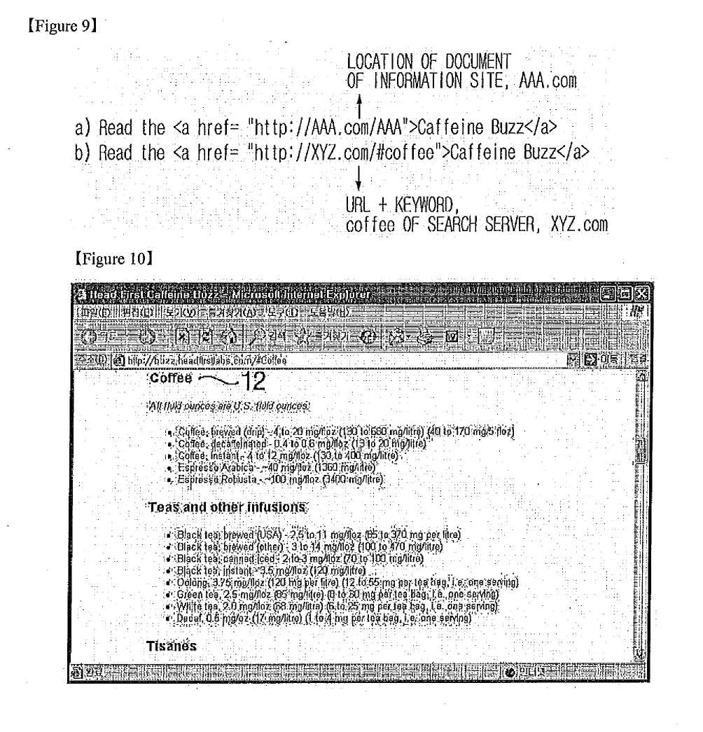

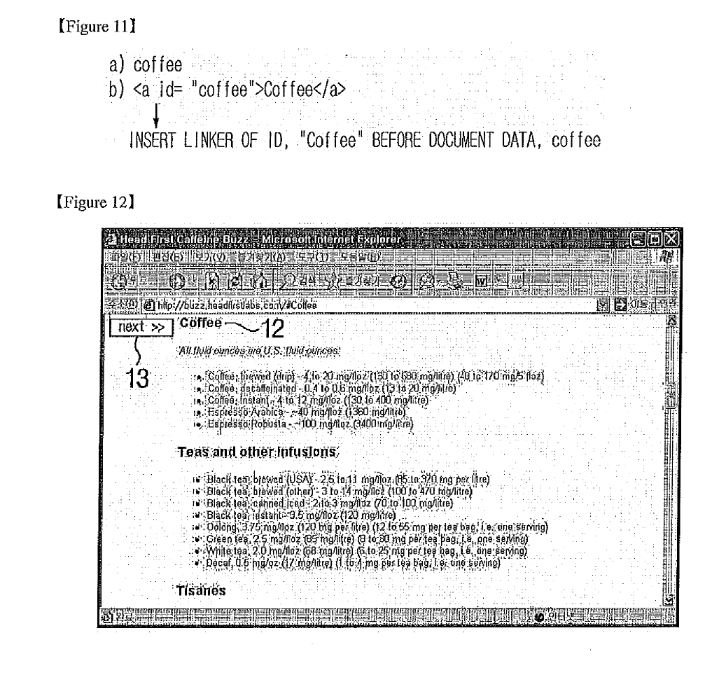

Hereinafter, the double link search method according to an embodiment of the present invention is described in detail with reference to FIGS. 7 to 12. FIG. 7 is a flow chart illustrating a double link search method according to an embodiment of the present invention. FIG. 8 illustrates a display of a search result page to be provided after a user inputs a search keyword. FIG. 9 illustrates data of a link page address linked to a search result item of the search result page of FIG. 8. FIG. 10 illustrates a display of a link page to be provided when a user selects a specific link item on the search result page of FIG. 8. FIG. 11 illustrates ID data inserted before and after a search keyword data on the link page of FIG. 10. FIG. 12 illustrates a display of a link page having a “next” button, and in the case that a search keyword is positioned at a plurality of locations on a link page, the “next” button allows the user to directly move to a next sentence starting with the search keyword. And, it is possible to insert a direct connection button beside the “next” button, which allows the user to directly link to a corresponding information site 4.

Referring to FIG. 7, a user executes the web browser 30 in the user terminal 3, inputs a search keyword into an address window in the web browser 30 or a search window in a web page provided by a site of the search server 2, and executes a search. The search server 2 receives a search request including the search keyword from the user terminal 3 (S10).

After receiving the search request, the search server 2 collects search result data from Internet sites using the search keyword inputted by the user (S20).

After collecting the data, the search server 2 generates a unique URL of the search server 2 corresponding to a URL of the search result in the Internet sites, and stores ‘search site URL’ and ‘search server URL’ in a DB (S30).

After storing an address information, the search server 2 generates a search result page, in which a link address of each search result item is linked to the URL of the search server 2 (S40).

The generated search result page is provided from the search server 2 to the user terminal 3 (S50). FIG. 8 illustrates a search result page to be provided after the user inputs “coffee” as a search keyword. Referring to FIG. 9 a), conventionally, a link address of a search result item is an address of an actual information site 4 where data is located, “http://AAA.com/AAA”. However, in the present invention, as shown in FIG. 9 b), when generating a search result page, an address of an information site 4 is replaced with an address of the search server 2, “http://XYZ.com”. And, the search keyword of the user (an ID of the search keyword), “coffee” is included in the address of the search server 2, and thus the link address is “http://XYZ.com/#coffee”. Here, “http://XYZ.com” is just used as an example, and if it is an address information for connection to the search server 2, the address information is not limited to a specific format.

Preferably, the search result page of FIG. 8 may have a direct connection button for directly linking to an actual information site 4 for each search result item. This allows the user to directly link to the actual information site 4 and receive a unique service (sign up or product purchase) with ease.

After the search result is displayed on the user terminal 3, the user examines the search result items, selects a specific search result item and requests a link information. Then, the search server 2 receives the link page request from the user terminal 3 (S60). Referring to FIG. 8, the user selects a link item 11 on the search result page, and the search server 2 receives a corresponding URL address, “http://XYZ.com/#coffee”.

After receiving the link page request, the search server 2 searches a DB by its URL and extracts a URL of the actual information site 4 where data is located. The search server 2 requests a link page to the corresponding information site 4 based on the extracted URL and receives the link page (S70). For example, the search server 2 searches the DB by “http://XYZ.com” and extracts an actual data address, “http://AAA.com/AAA”. And, the search server 2 requests a link page to the extracted address, “http://AAA.com/AAA”.

After receiving the link page, the search server 2 analyzes data of the link page and inserts a unique ID into each location of the search keyword to edit the link page (S80). FIG. 11 a) illustrates an original link page data, and FIG. 11 b) illustrates data including a linker of an ID “coffee” inserted before and after the search keyword “coffee”.

After generating the link page with the ID, the search server 2 provides the link page to the user terminal 3. FIG. 10 illustrates the link page displayed on the user terminal 3, and the link page displays the search result starting with the search keyword “coffee” in the first line on a screen. FIG. 12 illustrates a display having the “next” button in the link page in the case that the search keyword “coffee” is positioned at least two locations on the link page. Whenever the user presses the “next” button, the user moves to a next sentence starting with the search keyword.

As such, embodiments of the double link search system and method for displaying search results starting with a search keyword according to the present invention are described. However, it should be understood that the detailed description and specific examples, while indicating preferred embodiments of the invention, are given by way of illustration only, since various changes and modifications within the spirit and scope of the invention will become apparent to those skilled in the art from this detailed description.

The double link search system and method for displaying search results starting with a search keyword according to the present invention displays search results starting with a corresponding search keyword in the case that a user selects a specific link item on a search result page to inquire out a detailed information, and thus the user can inquire out a desired information immediately without need to look for the search keyword directly.

1. A double link search system, which when a user inputs a search keyword in a wire or wireless network and inquires out search results, provides the user with a link page displaying a sentence starting with the search keyword, the system comprising:
means for receiving a search request including a search keyword from a user terminal;
means for collecting search results corresponding to the search keyword from information sites;
means for storing a URL (Uniform Resource Locator) of each information site where the search results are located and a unique URL of a search server corresponding to the URL of each information site;
means for generating a search result page including search result items, each item having the URL of the search server; and
means for providing the user terminal with the search result page.

2. The double link search system according to claim 1,
wherein, in the search result page,
each search result item has the URL of the search server, and the URL includes the search keyword.

3. The double link search system according to claim 1,
wherein the search server stores the generated search result page in a memory, and when receiving a search request of the same search keyword from the user terminal, the search server inquires out the stored search result page and responds to the user terminal.

4. The double link search system according to claim 1, wherein the search server includes:
means for receiving a request for a link page of a specific search result item using the URL of the search server of the search result page from the user terminal;
means for inquiring out a URL of an information site corresponding to the URL of the search server from a DB (database), requesting a link page, and receiving the corresponding link page from the information site;
means for inserting an unique ID (identification) information into each location of the search keyword among data of the received link page to edit the link page; and
means for providing the user terminal with the edited link page.

5. The double link search system according to claim 4, wherein, in the case that the search keyword is positioned at least two locations on the received link page,
the link page has a “next” button inserted therein, and when the “next” button is selected by a user, the “next” button allows the user to directly move to a next sentence starting with the search keyword.

6. The double link search system according to claim 1, wherein the search server inserts a connection button into each search result item of the search result page, the connection button giving a link to an actual information site of the search result item.

7. A double link search method, in which when a user inputs a search keyword in a wire or wireless network and inquires out search results, a search server provides the user with a link page displaying a sentence starting with the search keyword, the method comprising:
(810) a search server receiving a search request including a search keyword from a user terminal;
(S20) collecting search results corresponding to the search keyword from information sites;
(S30) storing a URL of each information site where the search results are located and a unique URL of the search server corresponding to the URL of each information site;
(S40) generating a search result page including search result items, each item having the URL of the search server; and
(S50) providing the user terminal with the search result page.

8. The double link search method according to claim 7,
wherein the step (S40) generates a search result page including each search result item having the URL of the search server, and the URL includes the search keyword.

9. The double link search method according to claim 7, wherein the step (S40) generates a search result page, in which a connection button is further inserted into each search result item to directly link to an actual site of the search result item.

10. The double link search method according to claim 7,
wherein the search server stores the generated search result page in a memory, and when receiving a search request of the same search keyword from the user terminal, the search server inquires out the stored search result page and responds to the user terminal.

11. The double link search method according to claim 7, further comprising:
(S60) receiving a request for a link page of a specific search result item using the URL of the search server of the search result page from the user terminal;
(870) inquiring out a URL of an information site corresponding to the URL of the search server from a DB, requesting a link page, and receiving the corresponding link page;
(S80) inserting a unique ID information into each location of the search keyword among data of the received link page to edit the link page; and
(890) providing the user terminal with the edited link page.

12. The double link search method according to claim 11,
wherein, in the case that the search keyword is positioned at least two locations on the received link page,
the step (880) inserts a “next” button into the link page, so that when the “next” button is selected by a user, the “next” button allows the user to directly move to a next sentence starting with the search keyword.

13. The double link search system according to claim 4, wherein the search server inserts a connection button into each search result item of the search result page, the connection button giving a link to an actual information site of the search result item.

14. The double link search method according to claim 8, wherein the step (S40) generates a search result page, in which a connection button is further inserted into each search result item to directly link to an actual site of the search result item.
